(19) United States
(12) Patent Application Publication
(10) Pub. No.: US 2006/0076003 A1
(43) Pub. Date: Apr. 13, 2006

(54) Foldable camping grill

(76) Inventors: Jerry Smolinsky, Van Nuys, CA (US); Jordan Smolinsky, Torrance, CA (US)

Correspondence Address: HOWARD LESLIE HOFFENBERG;LAW OFFICES OF HOWARD LESLIE HOFFENBERG, 8936 SOUTH SEPULVEDA, SUITE 105, LOS ANGELES, CA, 90045, US

(21) Appl. No.: 11/242,212

(22) Filed: Oct. 3, 2005

Related U.S. Application Data
(60) Provisional application No. 60/616,960, filed on Oct. 8, 2004.

(51) Int. Cl. A47J 37/07

(52) U.S. Cl. 126/9 R

(57) ABSTRACT

A foldable camping grill comprised of a foldable grill layout, at least three socket mounted support legs and a system of suspension braces that is independent of the support legs. When the grill layout is folded, one socket inserts into another socket to retain the layout in compact configuration for carrying.

### CROSS REFERENCE TO RELATED APPLICATIONS

We hereby claim the benefit of my earlier filed provisional application (application No. 60/60/616,960) filed Oct. 8, 2004.

### BACKGROUND OF THE INVENTION

1. Field of the Invention

The present invention relates to the field of culinary devices, and more particularly to a novel foldable grill for camping purposes which includes a plurality of grill sections that are folded over upon each other to provide a compact storage configuration and deployable into a full grill layout in an operable position. A detachable fire bed is included.

2. Brief Description of the Prior Art

In the past, it has been the conventional practice to use a single grill over a fire bed area which is rigid and may be detachably connected to each other. The fire bed may take the form of a box-like structure having propane or alcohol fuel or may include the earth or rocks for supporting the rigid grill over a fire area.

Difficulties and problems have been encountered with such prior grills in that the grills are single piece and are usually large and cumbersome to pack, store and transport. Such grills do not easily fit into backpacks or carrying cases because of the size and rigidity of the grill.

Therefore, a long-standing need has existed to provide a folding grill that may readily be deployed into an operative position for use over a fire bed and that may be folded into a compact configuration readily carryable in a backpack or the like. A portable fire bed may be included into the folding grill combination for convenience of packing and usage.

### SUMMARY OF THE INVENTION

Accordingly, the above problems and difficulties are avoided by the present invention which provides a foldable grill apparatus having a plurality of grill sections which are hinged at strategic locations in order to permit the grill sections to be folded over upon themselves to provide a compact storage configuration. The hinge arrangement permits deployment of the grill sections into a side-by-side flat grill arrangement that is supported by adjustable legs for support over a fire bed. A portable fire bed plate may be included which is detachably connected to the supporting legs in spaced-apart relationship with respect to the unfolded grill sections. The unfolded grill sections may be supported in a frame by a variety of suitable means; however, notched members may be carried on the frame for receiving brace members carried on the underside of the respective folding grill sections.

The grill is detachably supported on the braces and frame while the frame is supported by the support legs either over the fire bed, taking the form of the ground or rocks, or the detachable fire bed may be employed under the unfolded grill sections.

Therefore, it is among the primary objects of the present invention to provide a novel folding camping grill which includes a plurality of grill sections that are folded over upon one another into a storage condition or deployed by unfolding into an operative position suitable for cooking purposes.

Another object of the present invention is to provide a folding grill that is detachably supported by a frame and support legs either over the ground or rocks as a fire bed or which may include a detachable fire bed under the deployed grill sections.

Still a further object of the invention is to provide a foldable grill that may be unfolded from a storage position into an operative position that can be supported on rocks, adjustable support leg members or the like.

A further object resides in providing a foldable camping grill for cooking purposes which is readily deployable from a storage position into an operative position that may be readily carried in a pack, case or the like for transport purposes.

### BRIEF DESCRIPTION OF THE DRAWINGS

The features of the present invention which are believed to be novel are set forth with particularity in the appended claims. The present invention, both as to its organization and manner of operation, together with further objects and advantages thereof, may best be understood with reference to the following description, taken in connection with the accompanying drawings in which:

FIG. 1 is a perspective view of the novel foldable camping grill incorporating the present invention;

FIGS. 2-5 inclusive illustrate the foldability of the grill shown in FIG. 1 from its deployed position back into a storage position;

FIG. 6 is a fragmentary sectional view showing a typical hinge joining adjacent edge marginal regions of a pair of grill sections as taken in the direction of arrows 6-6 of FIG. 2;

FIG. 7 is a fragmentary sectional view as taken in the direction of arrows 7-7 of FIG. 3;

FIG. 8 is a fragmentary sectional view as taken in the direction of arrows 8-8 of FIG. 4;

FIG. 9 is a fragmentary sectional view of a corner of a deployed grill supported on a support leg as shown in FIG. 1 taken in the direction of arrows 9-9;

FIG. 10 is a reduced side elevational view, partly in section, illustrating the attachment of a fire bed to a supporting leg;

FIG. 11 is a side elevational view showing height adjustment for the foldable grill in accordance with the present invention;

FIG. 12 is a sectional view of a portion of the attachment of adjacent leg supports shown in FIG. 11 as taken in the direction of arrows 12-12 thereof;

FIG. 13 is a perspective view illustrating the frame and braces incorporated into the foldable camping grill of the present invention; and

FIG. 14 is a perspective view of a typical brace used in the configuration shown in FIG. 13.

### DESCRIPTION OF PREFERRED EMBODIMENT

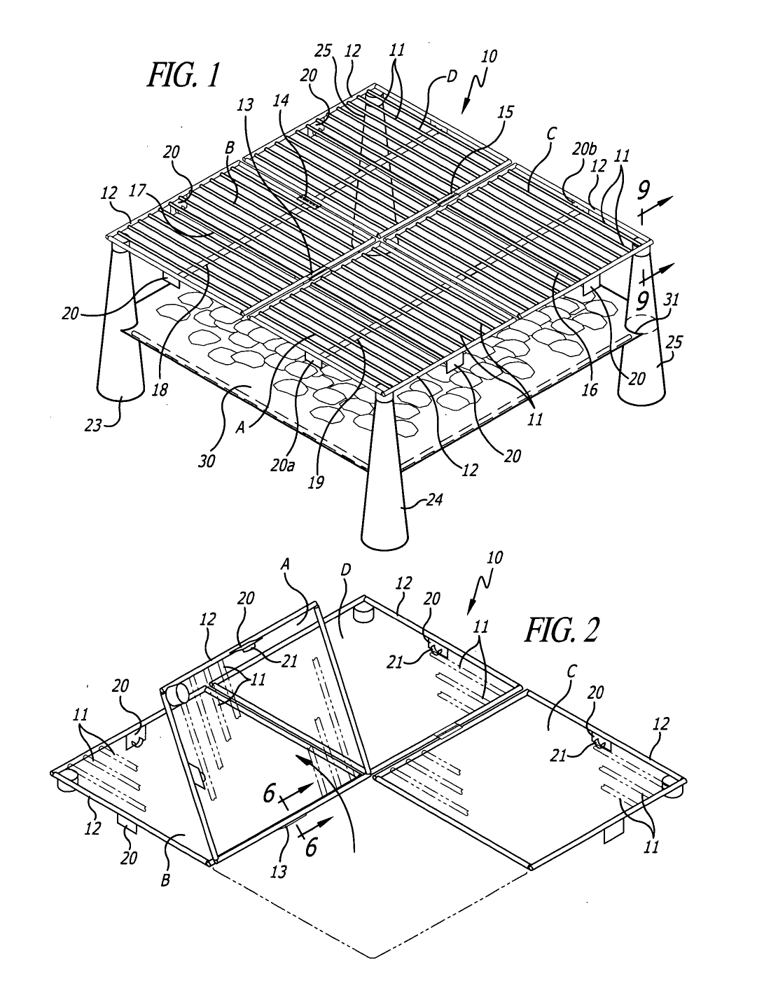

Referring to FIG. 1, the novel folding camp grill 10 is illustrated in the general direction of numeral 9 and includes a plurality of grill sections identified by letters A, B, C and D. The grill sections are arranged in their deployed position so as to provide a flat grill surface of sufficient area on which cooking can take place. Each of the respective grill sections, such as Section A for example, includes a plurality of cross-bars 11 which have their opposite ends secured or fixed to a frame 12 by welding or other securement. Therefore, each of the respective grill sections are individual and complete with their respective cross-bars extending between the frame. FIG. 1 also illustrates that the plurality of grill sections are joined by a plurality of hinges. For example, the adjacent sides of grill sections A and B are joined by a hinge 13. Also, it can be seen that the adjacent frames of grill sections B and D are coupled together by hinge 14 while the adjacent frames of grill sections C and D are coupled by hinge 15. A plurality of braces are extended beneath the grill sections for support purposes and it can be seen that numeral 19 is a brace extending under grill sections A and C and brace 18 extends under grill sections B and D. Brace 16 is extended beneath grill sections C and D and preferable in supporting relation under braces 18 and 19. Brace 17 extends under the grill sections A and B and preferably in supporting relation under braces 18 and 19. These braces 18 and 19 are perpendicular with respect to braces 16 and 17.

The opposite end of each brace is detachably supported in a bracket, such as bracket 20a, supporting one end of brace 19 while a bracket 20b supports the opposite end of the brace. The respective brackets are integral with or fixed to the frames 12 of each grill section and include a retainer 21 which is preferably U-shaped as illustrated in FIG. 13. The end of brace 16 fits into retainer 21a while the end of brace 19 detachably fits into the retainer 22 which is carried on the frame of grill section C.

FIG. 1 further illustrates that the deployed grill sections are elevated above the ground by means of support legs 23-26 inclusive. The upper end of each support leg terminates in a socket 27, such as shown in FIG. 9, which downwardly depends from the frame, such as frame of grill section C. The upper end of support leg 25 is inserted into the socket 27 as shown in FIG. 9 with the understanding that the top end or distal end of each of the support legs is inserted into respective sockets with respect to the other grill sections.

In FIG. 1, a fire bed 30 may be used by placing the fire bed in spaced relationship beneath the deployed grill sections so that portions of the edge marginal regions of the fire bed 30 can be inserted into slots, such as slot 31 in support leg 25. Thus, the fire bed is maintained in fixed parallel spaced-apart relationship with respect to the underside of the deployed grill sections. Coals or other combustible materials can be placed on the fire bed to provide heat for cooking of foods on the top of the grill.

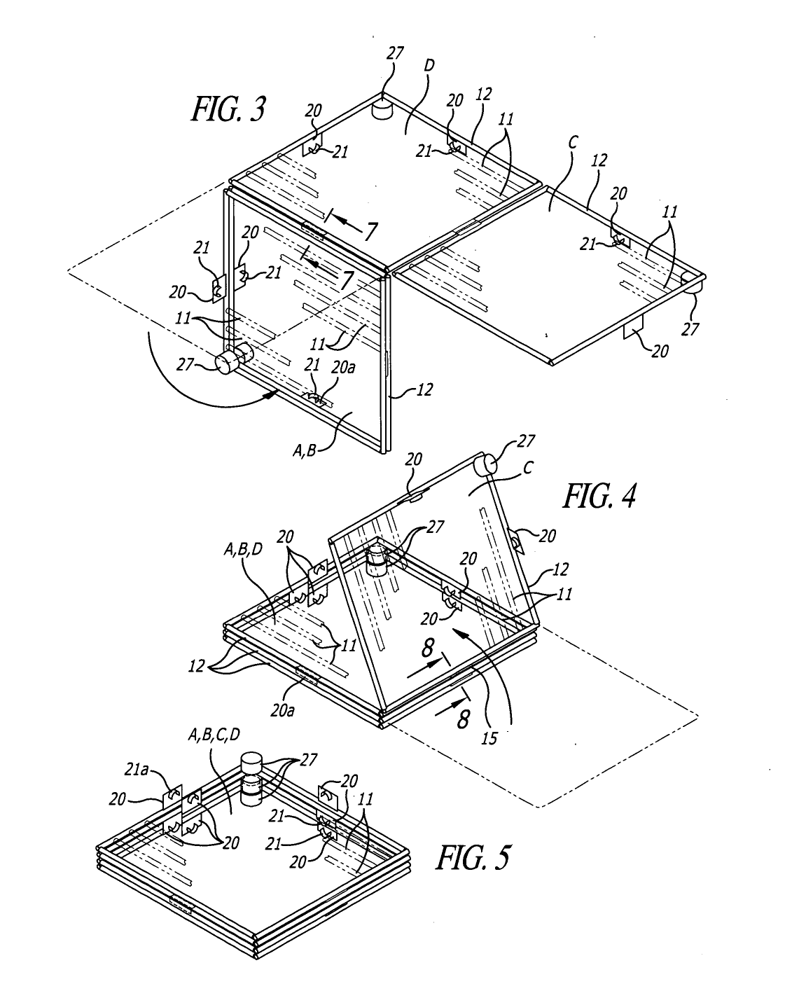

Referring now in detail to FIGS. 2-5 inclusive, the folding of the foldable grill 10 is illustrated in various steps of folding so that the grill assumes a compact storage condition. In FIG. 2, it can be seen that grill section A is pivoted on hinge 13 over grill section B along axis 6. In FIG. 3, the combined grill sections A and B are pivoted on hinge 14 to the-underside of grill section D along axis 7. In FIG. 4, grill section C is pivoted on hinge 15 over the top of grill section D along axis 8 to provide the compact arrangement, as shown in FIG. 5. The foldable grill is in position for storage in a bag, case, backpack or the like.

FIG. 6 shows the pivoting of section A with respect to grill section B on pivot 13 while FIG. 7 illustrates the pivoting of sections A and B to the underside of grill section D via hinge 14. In FIG. 8, grill section C is pivoted on hinge 15 to the top of grill section D to complete the compact arrangement.

In FIG. 9, the distal end of support leg 25 is inserted into the socket 27 so that the deployed grill can be supported on the ground or other supporting medium

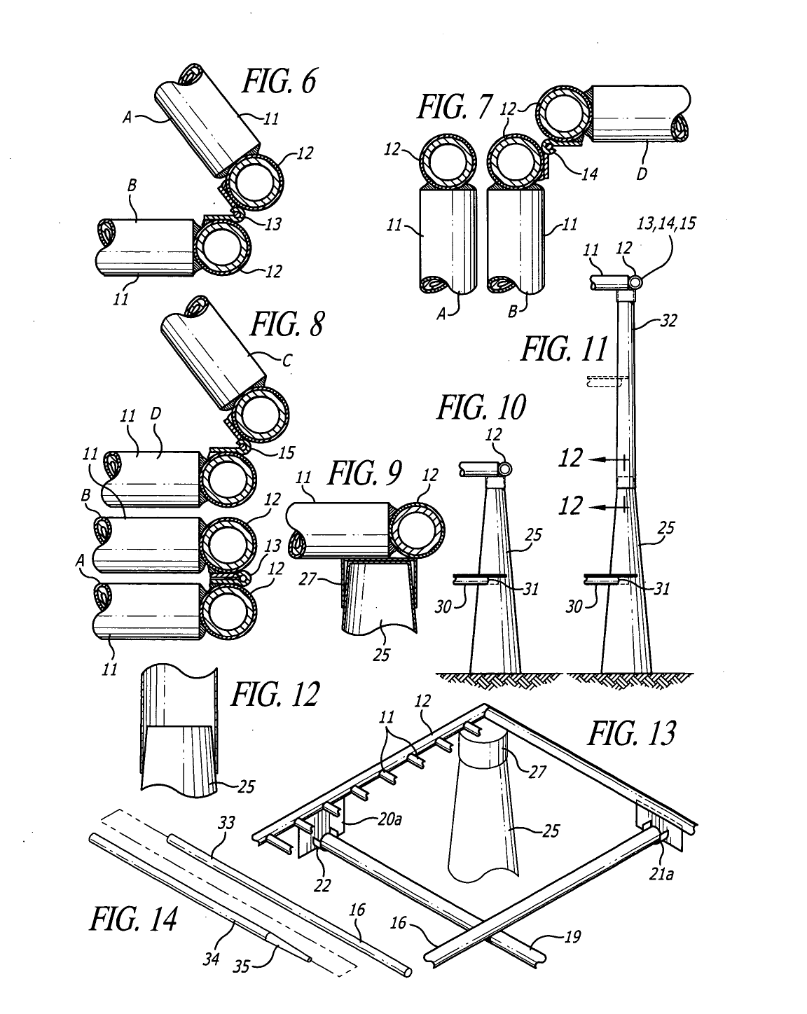

In FIG. 10, the edge of fire bed 30 is introduced to slot 31 in a leg, such as support leg 25. Each corner of the fire bed is thus supported by a separate support leg.

In FIG. 11, it can be seen that the height of the deployed grill may be elevated by including an extension 32 having one end carried on the distal end of support leg, such as support 25, while the elevated end of extension 32 fits into the socket on the underside of the frame of the deployed fire bed. It is understood that each of the respective legs 23-26 inclusive may accommodate extensions for elevating the fire bed and/or the deployed grill.

In FIG. 12, the joining of extension 32 with the distal end of a support leg, such as support leg 25, is illustrated. It can be seen that the distal end is tapered so as to easily be inserted into either a socket, such as socket 27, or into the end of extension, such as extension 32.

Referring now in detail to FIG. 13, it can be seen that the opposite ends of the braces, such as braces 16 and 19, will fit into retainers 21a and 22 respectively. The opposite ends of the braces are fitted into similar retainers on the brackets as previously described.

FIG. 14 illustrates a single brace, such as brace 16, which includes a pair of segments 33 and 34 wherein the end of segment 34 is tapered so as to be easily inserted into an opening in the end of segment 33. The segment 33 may take the form of a tube which is open-ended or may be a solid rod having an opening at one end to receive the tapered end 35 of segment 34.

In view of the foregoing, it can be seen that the deployed grill, shown in FIG. 1, may have the grill sections folded over upon themselves so as to assume the compact storage condition shown in FIG. 5. When ready for use, the grill may be readily deployed by reversing the unfolding of grill sections from that shown in FIGS. 2-4. Once fully deployed, the support legs may be installed into the respective sockets so that the grill is supported over a fire bed. The fire bed may be the ground or may even be rocks that will retain heat after a fire has been started. The fire bed may also take the form of the fire bed 30 which is inserted into slots in the respective legs so that both the deployed grill and the fire bed are supported by the legs. At this time, coals or other combustible materials are placed on the fire bed under the grill so that a cooking procedure can be commenced.

The grill layout can be used by placing it over an in-ground or stationary fire pit or fire barrel at campsite without legs or a fire bed. This is facilitated by the braces with mount to the grill section frames and are independent of the legs. In this application, the grill layout serves a sanitary cooking surface.

The foldable camping grill of the present invention has many advantages over the prior art. One of the advantages is stability. Another advantage is the degree compactness to which the foldable camping grill is foldable for storage and transport. Another advantage is the ease of assembly. Another advantage is its lightweight.

We claim:

1. A foldable grill kit comprised of:
a. at least three support legs for elevating above ground having a distal end for insertion into a socket;
b. a plurality braces with each brace having opposite brace ends;
c. a foldable grill layout comprised of:
i. a plurality of grill sections with each grill section having:
1. a frame,
2. a plurality of crossbars extending between the frame providing an about flat grill surface and a section underside,
3. zero or more brackets carried on the section underside with each bracket positioned for detachably supporting a brace end where there are four brackets on the grill undersides of the layout positioned for detachably supporting a first and second brace in a perpendicular configuration where the first brace extends under and supports the crossbars of grill sections and the second brace extends under and supports the first perpendicular brace and
4. zero or more sockets on the section underside depending downward where there are three sockets on the grill undersides of the layout positioned for insertion into the distal end of a support leg so as to elevate the unfolded grill layout above ground and
ii. a hinge arrangement such that the grill sections are foldable over upon each other to provide a compact storage configuration and deployable into a side-by-side about flat full grill layout with an underside.

2. The foldable grill kit of claim 1 where the foldable grill layout is comprised of a first and second grill sections and each has a socket positioned such that when the grill sections are folded over upon each other in compact storage configuration the socket of the first foldable grill section inserts into the socket of the second grill section.

3. The foldable grill kit of claim 1 where the grill layout is comprised of a first, second, third and fourth grill sections with each grill section having a square configuration and four sides where a side of the first grill section is adjacent to a side of the second grill section and joined by a hinge, where a another side of the second grill section is adjacent to a side of the fourth grill section and joined by a hinge, where a side of the third grill section is adjacent to another side of the fourth grill section and joined by a hinge, such that the first grill section pivots over the second grill section, the combined first and second grill sections pivots under the fourth grill section and the third grill section pivots over the fourth grill section.

4. A foldable grill kit comprised of:
a. four support legs for elevating above ground having a distal end for insertion into a socket;
b. a first, second, third and fourth brace with each having opposite brace ends;
c. a foldable grill layout comprised of:
i. a first, second, third and fourth grill sections with each grill section having a frame with a square configuration and four sides and a plurality of crossbars extending between the frame so as to provide an about flat grill surface and a section underside;
ii. a hinge arrangement where a side of the first grill section is adjacent to a side of the second grill section and joined by a hinge, where another side of the second grill section is adjacent to a side of the fourth grill section and joined by a hinge, where a side of the third grill section is adjacent to another side of the fourth grill section and joined by a hinge, such that the first grill section pivots over the second grill section, the combined first and second square grill sections pivots under the fourth grill section and the third square grill section pivots over the fourth square grill section to provide a compact storage configuration and deployable into a side-by-side about flat full grill layout with an underside,
iii. eight brackets for detachably supporting brace ends carried on the section undersides of the grill sections where the brackets are positioned for detachably supporting the first and second braces in a perpendicular configuration with the third and fourth braces such that the first and second braces extend under and support the crossbars of grill sections and the third and fourth braces extends under and support first and second braces and
iv. a socket on the section underside of each of the grill sections that depends downward with each socket positioned for insertion into the distal end of a support leg so as to elevating the unfolded grill layout above ground.

5. The foldable grill kit of claim 4 where the sockets of the first and fourth grill sections are positioned such that when the grill sections are folded over upon each other in compact storage configuration the socket of the first grill section inserts in the socket of the fourth grill section.

6. The foldable grill kit of claim 4 further comprising a plurality of extensions equal in number to a multiple of the number of support legs with each extension having a first end that carries on the distal end of a support leg and a second end that fits into a socket.

7. The foldable grill kit of claim 4 where a brace is comprised of a plurality of segments having a first segment end that is tapered and a second segment end that is open to receive a tapered segment end.

8. The foldable grill kit of claim 4 further comprising a detachable fire bed having edge marginal regions and where the support legs have slots for insertion of the edge marginal region of the fire bed with the slots positioned such that the fire bed is maintainable in fixed parallel spaced apart relationship with respect to the underside of the deployed full grill layout.

9. The foldable grill kit of claim 5 further comprising a plurality of extensions equal in number to a multiple of the number of support legs with each extension having a first end that carries on the distal end of a support leg and a second end that fits into a socket; where a brace is comprised of a plurality of segments having a first segment end that is tapered and a second segment end that is open to receive a tapered segment end; a detachable fire bed having edge marginal regions and where the support legs have slots for insertion of the edge marginal region of the fire bed with the slots positioned such that the fire bed is maintainable in fixed parallel spaced apart relationship with respect to the underside of the deployed full grill layout.

10. A foldable grill comprised of:
a. an about flat full grill layout comprised of unfolded sections of a plurality of grill sections having a hinge arrangement that are foldable upon each other into a compact storage position and where each grill section is comprised of:
i. a frame,
ii. a plurality of crossbars extending between the frame providing an about flat grill surface and a section underside;
iii. zero or more brackets on the section underside positioned for detachably supporting a brace end where there are four brackets on the section undersides of the plurality of grill sections which are positioned for detachably supporting a first and second brace in a perpendicular configuration where the first brace extends under and supports the crossbars of grill sections and the second brace extends under and supports the first perpendicular brace and
iv. zero or more sockets on the section underside depending downward and positioned for insertion into the distal ends of support legs with the number of sockets on the undersides of the frames of the plurality of grill sections is at least equal to the number of support legs;
c. two or more braces with each brace having opposite ends which extend underneath the grill sections for support purposes with opposite ends of the braces detachably fitted into brackets and where a first and second brace are in a perpendicular configuration with the first brace extending under and supporting crossbars of grill sections and the second brace extending under and supporting the first perpendicular brace and
d. at least three support legs with each having a distal end inserted into a socket so as to elevate the full grill layout above ground.

11. The foldable grill of claim 10 where the grill layout is comprised of a first and second grill sections and each has a socket positioned such that when the grill sections are folded over upon each other in compact storage configuration the socket of the first foldable grill section inserts into the socket of the second grill section.

12. The foldable grail of claim 10 where the full grill layout is comprised of a first, second, third and fourth square grill sections with each grill section having a square configuration and four sides where a side of the first grill section is adjacent to a side of the second grill section and joined by a hinge, where a another side of the second grill section is adjacent to a side of the fourth grill section and joined by a hinge, where a side of the third grill section is adjacent to another side of the fourth grill section and joined by a hinge, such that the first grill section pivots over the second grill section, the combined first and second grill sections pivots under the fourth grill section and the third grill section pivots over the fourth grill section.

13. A foldable grill comprised of:
a. an about flat full grill layout that is foldable into a compact storage position comprised of:
i. an unfolded first, second, third and fourth grill sections with each grill section having a frame with a square configuration and four sides and a plurality of crossbars extending between the frame so as to provide an about flat grill surface and a section underside and
ii. a hinge arrangement where a side of the first grill section is adjacent to a side of the second grill section and joined by a hinge, where another side of the second grill section is adjacent to a side of the fourth grill section and joined by a hinge, where a side of the third grill section is adjacent to another side of the fourth grill section and joined by a hinge, such that the first grill section pivots over the second grill section, the combined first and second square grill sections pivots under the fourth grill section and the third square grill section pivots over the fourth square grill section to provide a compact storage configuration and deployable into a side-by-side about flat full grill layout with an underside,
b. eight brackets for detachably supporting brace ends carried on the section undersides of the grill sections where the brackets are positioned for detachably supporting first and second braces in a perpendicular configuration with third and fourth braces such that the first and second braces extend under and support the crossbars of grill sections and the third and fourth braces extends under and support first and second braces
c. four sockets on the section underside depending downward positioned for insertion into the distal ends of the support legs where there are sockets on the first and fourth grill sections that are positioned such that when the grill sections are folded over upon each other in compact storage configuration the socket of the first grill section inserts in the socket of the fourth grill section.
e. a first, second, third and fourth brace which are detachably supported by brackets where the first and second brace are in a perpendicular configuration with the third and fourth brace and the first and second brace extend under and support crossbars of grill sections and the third and fourth brace extend under and support the first and second and
f. four support legs with each having a distal end for insertion into a socket and inserted into a socket so as to elevate the full grill layout above ground.

14. The foldable grill of claim 13 where a brace is comprised of a plurality of segments having a first segment end that is tapered and a second segment end that is open to receive a tapered segment end.

15. The foldable grill of claim 13 where in place of element e there is four support legs having a distal ends and four extensions with each extension having a first end that carries on the distal end of a support leg and a second end that fits into a socket with each second end inserted into a socket so as to elevate the full grill layout above ground.

16. The foldable grill kit of claim 13 further comprising a detachable fire bed having edge marginal regions and where the support legs have slots for insertion of the edge marginal region of the fire bed with the slots positioned such that the fire bed is maintainable in fixed parallel spaced apart relationship with respect to the underside of the deployed full grill layout.

17. The foldable grill of claim 14 where in place of element e there is four support legs having a distal ends and four extensions with each extension having a first end that carries on the distal end of a support leg and a second end that fits into a socket with each second end inserted into a socket so as to elevate the full grill layout above ground; a detachable fire bed having edge marginal regions and where the support legs have slots for insertion of the edge marginal region of the fire bed with the slots positioned such that the fire bed is maintainable in fixed parallel spaced apart relationship with respect to the underside of the deployed full grill layout.
